(19) United States
(12) Patent Application Publication
(10) Pub. No.: US 2021/0130099 A1
(43) Pub. Date: May 6, 2021

(54) SYSTEM FOR CONVEYING LOADS BETWEEN A PLURALITY OF STORAGE UNITS AND A PLURALITY OF PREPARATION STATIONS, VIA A LOAD ROUTING NETWORK DISTRIBUTED ON TWO HORIZONTAL PLANES

(71) Applicant: SAVOYE, Dijon (FR)

(72) Inventors: Jean-Michel Collin, Merceuil (FR); Stephane Pietrowicz, Fixin (FR)

(21) Appl. No.: 16/628,188

(22) PCT Filed: Jul. 5, 2018
(86) PCT No.: PCT/EP2018/068252

§ 371 Date: Jan. 2, 2020

(30) Foreign Application Priority Data
Jul. 7, 2017 (FR) 1756452

(51) Int. Cl. B65G 1/137; B65G 1/04; B65G 47/68; B65G 1/06

(52) U.S. Cl. CPC B65G 1/1378; B65G 1/06; B65G 47/68; B65G 1/0485

(57) ABSTRACT

A system for conveying loads without sequencing, between storage units and preparation stations. The system includes upper collectors and lower collectors of opposite directions, rectilinear, parallel and positioned on upper and lower horizontal planes respectively; and for at least one first storage unit/preparation station couple, a first set of conveyors composed of two storage unit upper exit and upper entry conveyors and two storage unit lower exit and lower entry conveyors to connect the storage unit to the collectors and two preparation station upper exit and upper entry conveyors and two preparation station lower exit and entry conveyors to connect the preparation station to the collectors.

### 1. CROSS-REFERENCE TO RELATED APPLICATIONS

This Application is a Section 371 National Stage Application of International Application No. PCT/EP2018/068252, filed Jul. 5, 2018, the content of which is incorporated herein by reference in its entirety, and published as WO 2019/008097 on Jan. 10, 2019, not in English.

### 2. TECHNICAL FIELD

The field of the invention is that of logistics.

More specifically, the invention relates to a system for conveying loads without sequencing, between a plurality of storage units and a plurality of preparation stations.

The storage units correspond for example to the different exits from alleys in an automated storage/removal warehouse.

The term “sequencing” (or “providing sequenced loads”), is understood to mean the providing, under a constraint of delivery, of at least one sequence comprising loads in a desired sequential order.

In the context of the present invention, it is assumed that in the outbound direction, the loads are conveyed from the storage units up to the preparation stations without being sequenced, and that the sequencing (if there is one) is done in each of the preparation stations. In other words, if a sequencing is needed, it is assumed that each preparation station is equipped for this purpose with a buffer storage and load sequencing system, for example, one of the types described in the patent applications FR1563151 dated 22 December 2015 and FR1654863 dated 30 May 2016.

It is also assumed that the conveying system should be such that:
in the outbound direction, a load coming from any unspecified one of the storage units must be capable of being conveyed to any one whatsoever of the preparation stations or to any one whatsoever of the other storage units; and
in the return direction, a load coming from any unspecified one of the preparation stations must be capable of being conveyed to any unspecified one of the storage units or to any unspecified one of the other preparation stations.

The present invention can be applied to any type of preparation station, and especially but not exclusively to:
stations for preparing customer orders (also called “picking stations”) where the preparing is done by the picking of items or goods from a storage containers (also called “load sources”): an operator (or a robot) receives a pick list (on paper, on a terminal screen, in voice form, or in the form of computer tasks (when it is a robot), etc.). For each package to be shipped (also called a “shipping container” or “target load”), this list informs the operator or robot about the quantity of each type of items or goods that he or it must collect in storage containers and group together in the package to be shipped; and
stations for the palletization of storage containers (also called “source loads”) themselves containing items: an operator (or a robot) receives a pick list (on paper, on a terminal screen, in voice form, in the form of computer tasks (when it is a robot), etc. For each pallet to be shipped (also called a “shipping container” or “target load”), this list informs the operator or robot about the quantity of storage containers of each type (for example cardboard boxes) that he must collect and unload onto the pallet to be shipped.

### 3. TECHNOLOGICAL BACKGROUND

Referring now to FIG. 1, a top view is presented of an example of a known configuration for an automated storage system for preparing customer orders comprising:
an automated storage/removal warehouse 7 comprising several sets (two in this example) each formed by an alley 7a, 7a′ feeding, on either side, a storage shelf 7b, 7c, 7b′, 7c′ with several superimposed stacking levels;
a set of conveyors taking the source loads from the automated warehouse 7 up to the preparation stations and vice versa. In the example of FIG. 1, we can distinguish:
   for the forward or outbound operation (i.e. from the automated warehouse 7 up to the preparation stations), conveyors referenced 9a and 9a′ (one per alley) as well as 6 and 8; and
   for the return operation (i.e. from the preparation stations up to the automated warehouse 7), conveyors referenced 8′, 6′ as well as 9b and 9b′ (one per alley); in this example, the conveyor 6′ and 8′ are superimposed on the conveyors 6 and 8;
several customer-order preparation stations 10a to 10f, each occupied by an operator 1a to 1f and extending perpendicularly to the conveyors referenced 8 and 8′; and
a management system (also called a management unit) that is a computer-based central management system responsible for managing the entire system (the automated storage/removal warehouse 7, the set of conveyors 6, 6′, 8, 8′, 9a, 9a′, 9b and 9b′ and the preparation stations 10a to 10f).

The management system also manages the list of customer orders associated with each shipping container (target load) and therefore the sequential order of the customer order lines forming this list, as a function of the location of the storage containers (source loads) in the automated warehouse 7, the availability of the trolleys and the elevators of the automated warehouse 7 as well as requirements in terms of items and goods of the different shipping containers to be prepared that succeed one and other at the preparation station. The purpose of this is to optimize all the movements and the preparation times for the shipping containers and ensure synchronization between the arrival, at the preparation station, of a shipping container and the corresponding storage containers (containing goods indicated in the customer order list associated with this storage container).

In the example of FIG. 1, each preparation station comprises two conveyor circuits: a first conveyor circuit for the storage containers, formed by two horizontal columns of conveyors; one column (the forward or outbound column 3) for moving the storage containers from the third sub-set of conveyors 8 up to the operator 1a and the other column (the return column 2) for the reverse movement; and a second circuit of conveyors for the shipping containers, formed by two horizontal columns of conveyors: one (forward or outbound column 4) for moving the shipping containers from the third sub-set of conveyors 8 up to the operator 1a and the other (return column 5) for the reverse movement.

A buffer storage function (also called an “accumulation function”) for buffering a determined quantity of containers upstream to the operator (or automaton) is set up in each of the first and second circuits, by the outbound column 3 and 4 (composed of classic horizontal conveyors). A storage container therefore makes the following journey: it is picked up by a trolley in the automated warehouse 7, and is then conveyed successively by one of the conveyors 9a and 9a′ (depending on whether it arrives from the alley 7a or 7a′) and by the conveyors 6 and 8 and finally by the conveyors of the forward or outbound column 3 to be presented to the operator. In the other direction (after presentation to the operator), the storage container makes the reverse journey: it is conveyed by the conveyors of the return column 2, then by the conveyors 8′ and 6′ and finally by one of the conveyors 9b and 9b′ (depending on whether it is returning to the alley 7a or the alley 7a′) and is then re-positioned in the automated warehouse 7 by means of a trolley.

As mentioned further above, the containers (source loads and target loads) has to be presented to the operator in a desired sequential order forming at least one determined sequence. Classically, this sequential order of arrival is pre-determined by the management system (i.e. it is determined, for each container, before this container reaches the preparation station) and, if necessary, recomputed during the conveying of the containers from the automated warehouse 7 exit to the preparation station (for example to cope with a malfunction of an element of the system).

In a first known implementation of the sequencing (i.e. the sequencing function), a first level of sequencing is obtained by the deposition of the pre-sequenced loads on each of the conveyors 9a and 9a′. There are therefore constraints on the automated warehouse 7. In other words, the loads deposited on the conveyor 9a are in a sequential order consistent with that of the final desired sequential order and the loads deposited on the conveyor 9a′ are also in a sequential order consistent with that of the final desired sequential order. Then, a second level of sequencing is achieved through the deposition on the conveyor 6, in the final desired sequential order, of the loads coming from the conveyors 9a and 9a′. For example, for a sequence of seven loads, if the loads of ranks 1, 2, 4 and 5 are stored in the alley 7a, they are deposited in this order on the conveyor 9a and if the loads of the ranks 3 and 6 are stored in the alley 7a′, they are deposited in this order on the conveyor 9a′; then, the seven loads are deposited on the conveyor 6 in ascending order (from 1 to 7) of their ranks.

In a second known implementation of the sequencing operation, in order to relax the constraints on the automated warehouse 7, it is accepted that the containers will not exit the automated warehouse 7 in the desired sequential order (i.e. the order in which they have to be presented to the operator). It is therefore necessary to carry out two operations, one for conveying and the other for sequencing the containers between the automated warehouse 7 and the preparation station where the operator is situated. The elimination of the sequencing constraints, which usually weigh on the automated warehouse 7, significantly increases the performance of this automated warehouse (and more generally of the different upstream devices) and therefore reduces its size and complexity and therefore its cost. In the example of FIG. 1, these conveying and sequencing functions are performed as follows for a given preparation station: the storage containers circulate in a loop (also called a carrousel) formed by the conveyors 6, 8, 8′ and 6′ and when the next storage container of the sequence awaited by the given preparation station comes before the outbound column 3 of this given preparation station, this storage container is transferred to the conveyors of the outbound column 3. A storage container must make a turn of the loop if it comes before the outbound column 3 of the given preparation station while at least one of storage containers that precede it in the sequence has not yet been transferred to the outbound column 3 of the given preparation station. This method is performed for each of the storage containers awaited in the sequence expected by the given preparation station.

It will be noted that in a known way, the above-mentioned principle of the loop (carrousel) is also used to carry out the single function of conveying loads (in FIG. 1, between on the one hand the entry conveyors 9b, 9b′/exit conveyors 9a, 9a′ of the alleys 7a, 7a′ of the automated store 7 and on the other hand the entry conveyors 3, 4/exit conveyors 2, 5 of the preparation stations 10a to 10f). In other words, if there is no sequencing or if the sequencing is done in each of the preparation stations, the carrousel or loop is used solely for conveying the loads. In this case, and returning to the example of FIG. 1, the storage containers circulate on the loop or carrousel formed by the conveyors 6, 8, 8′ and 6′ and, as soon as the storage container intended for the given preparation station comes before the outbound column 3 of this preparation station, it is transferred to this outbound column 3.

The use of a loop (carrousel) to carry out the load-conveying function but not the sequencing function is not an optimum solution in terms of distance travelled by the loads or even less in terms of quantity of loads that can be conveyed simultaneously.

Thus, in the example of FIG. 1, to carry out a round trip between one of the alleys 7a, 7a′ of the automated warehouse 7 and one of the preparation stations 10a to 10f, a load must travel through the entire loop.

In addition, certain sections of the loop are travelled by all the loads: on the outbound journey, the section situated between the connection point (on the conveyor 6 of the loop) of the exit conveyor 9a of the alley 7a and the connection point (on the conveyor 8 of the loop) of the entry conveyor 3 or 4 of the preparation station 10a; on the return journey, the section situated between the connection point (on the conveyor 8′ of the loop) of the exit conveyor 2 or 5 of the preparation station 10a and the connection point (on the conveyor 6′ of the loop) of the entry conveyor 9b of the alley 7a.

In the least favorable case, i.e. to travel the longest path (outbound or return) between one of the alleys 7a, 7a′ of the automated warehouse 7 and one of the preparation stations 10a to 10f, a load must pass before the other alley or alleys of the automated warehouse 7 and the other preparation station or stations. In the example of FIG. 1, to travel the longest outbound path between the alley 7a′ and the preparation station 10f, a load must pass before the other alley 7a and the other preparation stations 10a to 10e. Similarly, to travel through the longest return path between the preparation station 10f and the alley 7a, a load must pass before the other preparation stations 10a to 10e and before the other alley 7a.

### 4. SUMMARY OF THE INVENTION

One particular embodiment of the invention proposes a system for conveying loads without sequencing, between a plurality of storage units and a plurality of preparation stations. This system comprises:
an upper load-collecting conveyor and a lower load-collecting conveyor, that are rectilinear, parallel, respectively positioned on an upper horizontal plane and a lower horizontal plane, being mono-directional and having opposite directions that are respectively upper and lower directions; and
for at least one first couple comprising a storage unit and a preparation station facing each other on either side of the upper and lower load-collecting conveyors, a first set of conveyors composed of:
   a storage unit upper exit conveyor and a storage unit upper entry conveyor, positioned in the upper horizontal plane to connect said storage unit to the upper load-collecting conveyor;
   a storage unit lower exit conveyor and a storage unit lower entry conveyor, positioned in the lower horizontal plane to connect said storage unit to the lower load-collecting conveyor;
   a preparation station upper exit conveyor and a preparation station upper entry conveyor positioned in the upper horizontal plane to connect said preparation station to the upper load-collecting conveyor; and
   a preparation station lower exit conveyor and a preparation station lower entry conveyor, positioned in the lower horizontal plane to connect said preparation station to the lower load-collecting conveyor.

The general principle of the invention therefore consists in setting up, between the storage units and the preparation stations, a load-distribution network distributed on two horizontal planes (upper horizontal plane and lower horizontal plane) and having a structure comprising the following elements:
on the upper horizontal plane: upper load-collecting conveyor, storage unit upper exit conveyors, storage unit upper entry conveyors, preparation station upper exit conveyors and preparation station upper entry conveyors;
on the lower horizontal plane: lower load-collecting conveyor, storage unit lower exit conveyors, storage unit lower entry conveyors, preparation station lower exit conveyors and preparation station lower entry conveyors.

Owing to its distribution over two superimposed horizontal planes, this load conveying network does not require any elements providing for a direct junction between the upper and lower load-collecting conveyors.

In addition, it removes the need to use an endless loop (carousel) to set up the load-conveying function. This minimizes the distance travelled by each load and increases the quantity of loads that can be conveyed (routed) simultaneously.

According to one particular characteristic, for a conveying of loads between N storage units and N preparation stations, with N≥3, the system comprises N couples each comprising a storage unit and a preparation station that face each other on either side of the upper and lower load-collecting conveyors, and said N couples include:
N-2 said first couple(s) for each of which the system comprises said first set of conveyors;
a second couple, further upstream in the upper direction, and for which the system comprises a second set of conveyors identical to said first set of conveyors or distinct from it in that it does not include said storage unit upper entry conveyor; and
a third couple, furthest downstream in the upper direction and for which the system comprises a third set of conveyors identical to said first set of conveyors or distinct from it in that it does not include said preparation station upper exit conveyor. In this way, by maximizing the number of couples each comprising a storage unit and a preparation station facing each other, the distance travelled by the loads are further reduced and hence the quantity of loads that can be simultaneously conveyed is further increased.

### 5. LIST OF FIGURES

Other features and advantages of the invention shall appear from the following description, given by way of a non-exhaustive and indicatory example and from the appended drawings of which:

FIG. 1, already described with reference to the prior art, is a top view of an automated sequential order preparing system;

FIG. 2 illustrates a system for conveying loads according to a first embodiment of the invention (with four storage units and four preparation stations);

FIG. 3 illustrates a system for conveying loads according to a second embodiment of the invention (with four storage units and four preparation stations);

FIG. 4 illustrates a first example, in the context of the system of FIG. 2, of first example of outbound and return pathways for a load;

FIG. 5 illustrates a second example, in the context of the system of FIG. 2, of outbound and return pathways for a load;

FIG. 6 illustrates a third example, in the context of the system of FIG. 2, of outbound and return pathways for a load;

FIG. 7 illustrates a system for conveying loads according to a third embodiment of the invention (with two storage units and four preparation stations);

FIG. 8 illustrates a system for conveying loads according to a fourth embodiment of the invention (with five storage units and four preparation stations)

FIGS. 9A and 9B are respectively a top view and a view in perspective giving a detailed view of the elements of the system of FIG. 2 for a generic couple (A(x), P(x)) comprising a storage unit A(x) and a preparation station P(x) facing each other;

FIG. 10A gives a detailed view of the system of elevators included in the conveying system in the embodiments of FIGS. 2 to 8;

FIG. 10B illustrates a variant of the system of elevators of FIG. 10A; and

FIG. 10 is an example of a structure of a management unit according to one particular embodiment of the invention.

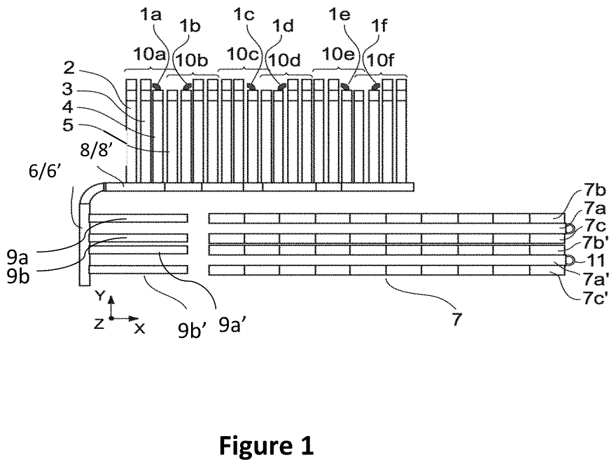

### 6. DETAILED DESCRIPTION

In all the figures of the present document, identical elements and steps are designated by a same numerical reference.

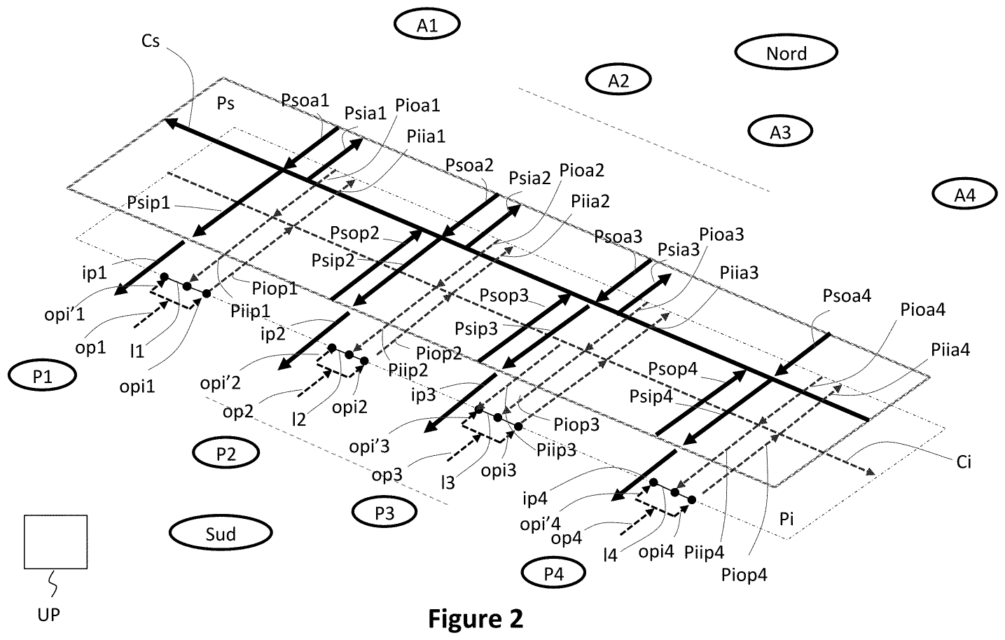

FIG. 2 illustrates a load-conveying system according to a first embodiment of the invention. It is configured to convey loads, without sequencing, between N storage units A1 to A4 (which correspond for example to the different alley exits of an automated storage/removal warehouse) and M preparation stations P1 to P4, with N=M=4. In variants of this first embodiment, we also have N=M, but with a value of N different from four.

As already mentioned further above, if a sequencing is necessary, it is assumed that each preparation station is equipped to this effect with a buffer storage and load sequencing system (for example one of the types described in the patent applications FR1563151 dated 22 Dec. 2015 and FR1654863 dated 30 May 2016).

The system comprises two collectors (i.e. collecting conveyors configured to collect loads), a plurality of conveyors and a managing unit. All these elements are described in detail here below.

In general, the direction of movement of each collector or conveyor (i.e. the direction of movement of the loads on this conveyor) is illustrated in the figures by the direction of the arrow schematically representing this collector or conveyor.

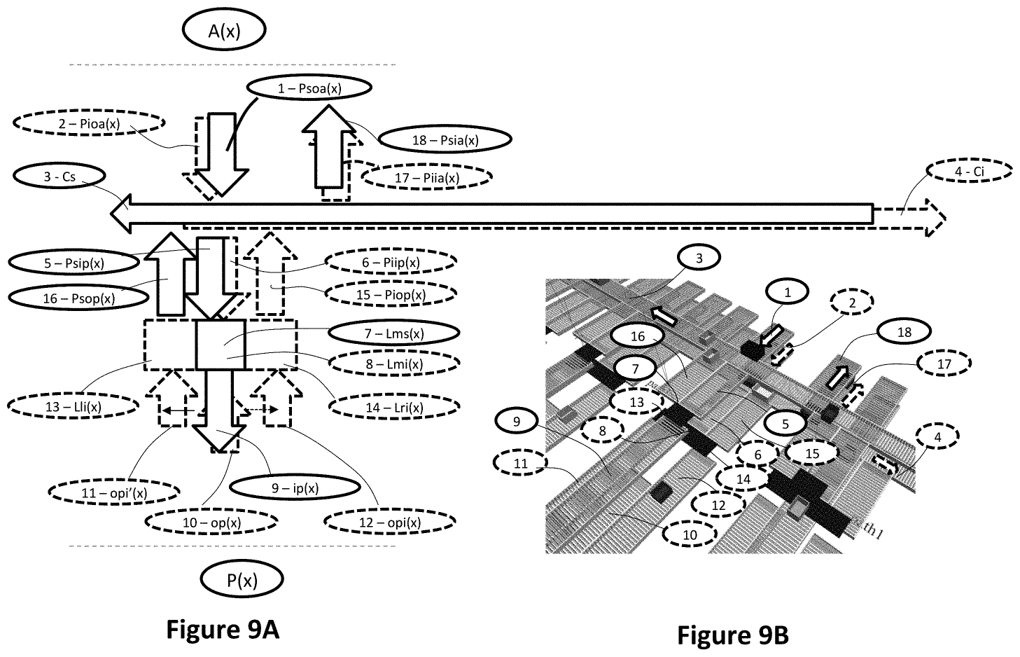

One of the collectors, called a “upper collector” is referenced Cs (or 3 in FIGS. 9A and 9B). The other, called a “lower collector” is referenced Ci (or 4 in FIGS. 9A and 9B). They are rectilinear, parallel and positioned respectively on an upper horizontal plane Ps and a lower horizontal plane Pi. They have opposite directions of movement (called “upper direction” and “lower direction” here below in the description). In FIG. 2, the direction of movement of the upper collector Cs is from right to left and that of the lower collector Ci is from left to right. In the particular embodiment of FIG. 2, the upper and lower collectors Cs, Ci are superimposed to reduce the space requirement of the system.

The four storage units A1 to A4 and the four preparation stations P1 to P4 form four couples (A1, P1), (A2, P2), (A3, P3), (A4, P4) each comprising a storage unit and a preparation station facing each other on either side of the upper and lower collectors Cs, Ci. In this way, by maximizing the number of couples each comprising a storage unit and a preparation station facing each other, the distance travelled by the loads is further reduced and therefore the quantity of loads that can be carried simultaneously is increased.

For each of the couples (A2, P2) and (A3, P3) (i.e. each of the couples situated between the couples most upstream and the couples most downstream in to the upper direction), the system will comprise a first set of conveyors formed by:
a storage unit upper exit conveyor Psoa2, Psoa3 (also referenced 1 in FIGS. 9A and 9B) and an entry unit upper storage conveyor Psia2, Psia3 (also referenced 18 in the FIGS. 9A and 9B), positioned in the upper horizontal plane to connect said storage unit to the upper collector;
a storage unit lower exit conveyor Pioa2, Pioa3 (also referenced 2 in the FIGS. 9A and 9B) and a storage unit lower entry conveyor Piia2, Piia3 (also referenced 17 in the FIGS. 9A and 9B), positioned in the lower horizontal plane to connect said lower storage unit to the lower collector;
a preparation station upper exit conveyor Psop2, Psop3 (also referenced 16 in FIGS. 9A and 9B) and a preparation station upper entry conveyor Psip2, Psip3 (also referenced 5 in FIGS. 9A and 9B), positioned in the upper horizontal plane to connect said preparation station to the upper collector; and
a preparation station lower exit conveyor Piop2, Piop3 (also referenced 15 in FIGS. 9A and 9B) and a preparation station lower entry conveyor Piip2, Piip3 (also referenced 6 in FIGS. 9A and 9B), positioned in the lower horizontal plane to connect said preparation station to the lower collector.

For the couple (A4, P4), which is the couple the most upstream in the upper direction, the system comprises a second set of conveyors which are distinguished from the first set of conveyors in that they do not comprise storage unit upper entry conveyors (Psia4). In one variant, the second set of conveyors is identical to the first set of conveyors.

For the couple (A1, P1), which is the value most downstream in the upper direction, the system comprises a third set of conveyors which is distinguished from the first set of conveyors in that it does not comprise any preparation station upper exit conveyor (Psop1). In one variant, the third set of conveyors is identical to the first set of conveyors.

In the particular embodiment of FIG. 2, the above-mentioned conveyors (Psoa(x), Psia(x), Pioa(x), Piia(x), Psop(x), Psip(x), Piop(x), Piip(x), with (x) ∈ {1, 2, 3, 4}) are perpendicular to the upper and lower collectors Cs, Ci. This facilitates the conveying of the loads between the storage units and the preparation stations. In one variant, there is no longer this kind of orthogonality between the collectors and the conveyors.

In the particular embodiment of FIG. 2, for each of the couples (A(x), P(x)), avec (x) ∈ {1, 2, 3, 4}, the following constraints are met in order to reduce the distances travelled by the loads:
the storage unit upper exit conveyor Psoa(x) is aligned with the preparation station upper entry conveyor Psip(x);
the storage unit lower exit conveyor Pioa(x) is aligned with the preparation station lower entry conveyor Piip(x); and
the preparation station lower exit conveyor Piop(x) is aligned with the storage unit lower entry conveyor Piia(x).

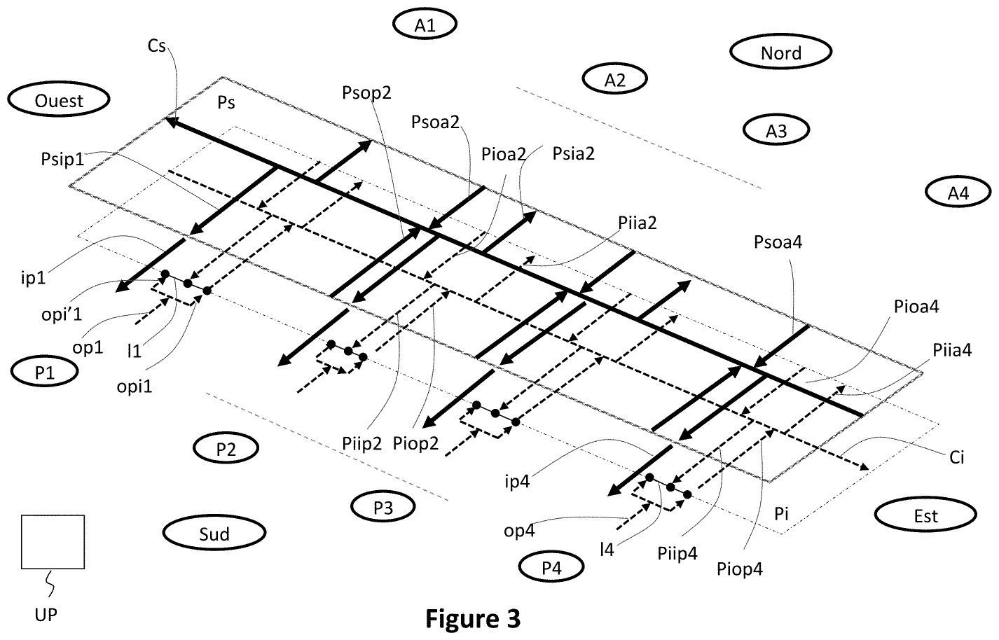

FIG. 3 illustrates a system for conveying loads according to a second embodiment of the invention, which is distinguished from the first in that the above-mentioned three constraints are no longer met. More specifically:
the storage unit upper exit conveyor Psoa(x) is upstream, in the upper direction, relative to the preparation station upper entry conveyor Psip(x);
the storage unit lower exit conveyor Pioa(x) is downstream, in the lower direction, relative to the preparation station lower entry conveyor Piip(x); and
the preparation station lower exit conveyor Piop(x) is upstream, in the lower direction, relative to the storage unit lower entry conveyor Piia(x).

In the particular embodiment of FIG. 2, for each of the couples (A(x), P(x)), with (x) ∈ {1, 2, 3, 4}, the following constraints are met in order to ensure an intersection of the incoming and outbound streams of the preparation station (both on the upper plane Ps and on the lower plane Pi):
the preparation station lower exit conveyor Piop(x) is downstream, in the lower direction, of the preparation station lower entry conveyor Piip(x);
the preparation station upper exit conveyor Psop(x) is downstream, in the upper direction, of the preparation station upper entry conveyor Psip(x).

Such a positioning of the preparation station exit conveyor (lower and upper) downstream (in the direction of the concerned collector) enables the transfer to the concerned collector of a load in exit from the preparation station even if, on the concerned collector, there is an accumulation of loads upstream (in the direction of the concerned collector) to that station.

In the particular embodiment of FIG. 2, for each of the couples (A(x), P(x)), with (x) ∈ {1, 2, 3, 4}, the following constraints are met in order to reduce the congestion in the system:
the storage unit upper exit conveyor Psoa(x) and the storage unit lower exit conveyor Pioa(x) are superimposed; and
the preparation station upper entry conveyor Psip(x) and the preparation station lower entry conveyor Piip(x) are superimposed.

In the particular embodiment of FIG. 2, for each preparation station P(x), with (x) ∈ {1, 2, 3, 4}, the system further comprises:
a preparation station final entry conveyor ip(x) (also referenced 9 in FIGS. 9A and 9B);
a preparation station initial exit conveyor op(x) (also referenced 10 in FIGS. 9A and 9B);
a first interface device between, on the one hand, the preparation station upper entry conveyor Psip(x) and the preparation station lower entry conveyor Piip(x) and, on the other hand, the preparation station final entry conveyor ip(x); and
a second interface device between, on the one hand, the preparation station initial exit conveyor p(x) and, on the other hand, the preparation station upper exit conveyor Psop(x) and the preparation station lower exit conveyor Piop(x).

Thus, the system is compatible with a preparation station which for its part is connected solely via a preparation station final entry conveyor ip(x) and a preparation station initial exit conveyor op(x).

We now present a particular implementation of the first interface device that reduces the congestion in the system. The preparation station upper entry conveyor Psip(x) and the preparation station lower entry conveyor Piip(x) are superimposed. The first interface device comprises a first elevator possessing at least one vertically mobile level Lmi(x) (also referenced 8 in FIGS. 9A and 9B). This level is for example equipped with an elevator conveyor and is configured for:
a first transfer of loads from the preparation station upper entry conveyor Psip(x) to the preparation station final entry conveyor ip(x) (without vertical movement if the preparation station final entry conveyor ip(x) is positioned in the upper plane Ps); and
a second transfer of loads from the preparation station lower entry conveyor Piip(x) towards the preparation station final entry conveyor ip(x) (with vertical movement from the lower plane Pi to the upper plane Ps if the preparation station final entry conveyor ip(x) is positioned in the upper plane Ps).

In one variant, in order to optimize the use of the first elevator, this elevator has two superimposed levels: a lower level Lmi(x) (also referenced 8 in FIGS. 9A and 9B) which corresponds to the one already described further above, and an upper level Lms(x) (also referenced 7 in FIGS. 9A and 9B). These lower and upper levels are configured to simultaneously enable:
the transfer to the upper level Lms(x) a load coming from the preparation station upper entry conveyor Psip(x), for the first load transfer; and
the transfer to the lower level Lmi(x) a load coming from the preparation station lower entry conveyor Piip(x), for the second load transfer.

We now present a particular implementation of the second interface device, which reduces the congestion of the system. The preparation station initial exit conveyor op(x) is positioned in the lower horizontal plane Pi. The second interface device comprises:
a first intermediate lower conveyor opi′(x) (also referenced 11 in FIGS. 9A and 9B) positioned in the lower horizontal plane, along a first lower axis parallel to the first upper axis of the preparation station upper exit conveyor Psop(x);
a second intermediate lower conveyor opi(x) (also referenced 12 in FIGS. 9A and 9B) positioned in the lower horizontal plane, along a same lower axis as the preparation station lower exit conveyor Piop(x);
a second elevator possessing at least one level Lli(x) (also referenced 13 in FIGS. 9A and 9B) vertically mobile, for example equipped with an elevator conveyor, and configured for a third transfer of loads from the first intermediate lower conveyor opi′(x) towards the preparation station upper exit conveyor Psop(x);
a junction conveyor (without vertical shift) or a third elevator possessing at least one level Lri(x) (also referenced 14 in FIGS. 9A and 9B) vertically mobile, for example equipped with an elevator conveyor, and configured for a fourth transfer of loads from the second intermediate lower conveyor opi(x) towards the preparation station lower exit conveyor Piop(x).

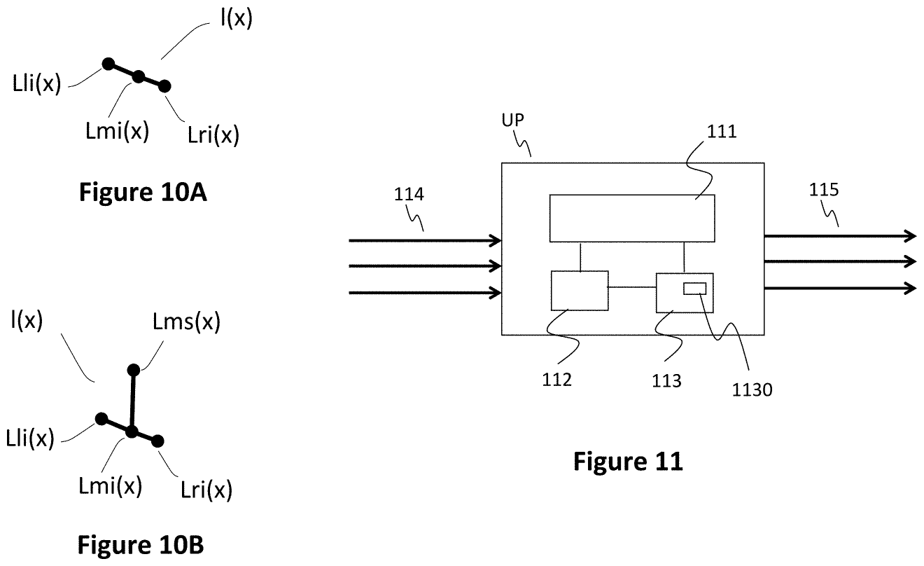

Thus, and as illustrated in FIGS. 10A and 10B, each station P(x) comprises a system of elevators (referenced 1(x) in FIG. 2) comprising the first elevator (which possesses the lower level Lmi(x) (the case of FIGS. 2, 9A, 9B and 10A) and possibly the upper level Lms(x) (the case of FIG. 10B)), the second elevator (which possesses the level Lli(x)) and the third elevator (which possesses the level Lri(x)). In one variant, the third elevator is replaced by junction conveyor (without vertical movement).

In one particular implementation of the system of elevators 1(x), the first and second elevators and the third elevator, if it is present, are made in the form of a single elevator comprising, on a same lower level (equivalent to a juxtaposition of levels Lli(x), Lmi(x) and Lri(x) described further above), first, second and third elevator conveyors configured to respectively carry out the second and third load transfers and possibly the fourth load transfer. Thus, the invention facilitates the implementing of the first and second elevators (and even the third).

FIGS. 9A and 9B are views, namely a top view and a view in perspective respectively, providing a detailed description of the elements of the system of FIG. 2 for a generic couple (A(x), P(x)) comprising a storage unit A(x) and a preparation station P(x) facing each other.

The table below recalls the correspondences between the references used in FIG. 2 and these FIGS. 9A and 9B.

| | | |
|---|---|---|
| 1 | Psoa(x) | Storage unit upper exit conveyor |
| 2 | Pioa(x) | Storage unit lower exit conveyor |
| 3 | Cs | Upper collector |
| 4 | Ci | Lower collector |
| 5 | Psip(x) | Preparation station upper entry conveyor |
| 6 | Piip(x) | Preparation station lower entry conveyor |
| 7 | Lms(x) | Upper level of the first elevator |
| 8 | Lmi(x) | Lower level of the first elevator |
| 9 | ip(x) | Preparation station final entry conveyor |
| 10 | op(x) | Preparation station initial exit conveyor |
| 11 | opi′(x) | First lower intermediate conveyor |
| 12 | opi(x) | Second lower intermediate conveyor |
| 13 | Lli(x) | (Lower) level of the second elevator |
| 14 | Lri(x) | (Lower) level of the third elevator |
| 15 | Piop(x) | Preparation station lower exit conveyor |
| 16 | Psop(x) | Preparation station upper exit conveyor |
| 17 | Piia(x) | Storage unit lower entry conveyor |
| 18 | Psia(x) | Storage unit upper entry conveyor |

In one particular implementation, it is sought to prevent the system from including unnecessary conveyors. To this end, various construction constraints for the system are met. They are described in detail here below. In the context of FIG. 2, they apply especially to the storage units A1 and A4 and to the preparation stations P1 and P4. More generally, they can be applied for example to any storage unit or any preparation station not included in a couple (A(x), P(x)), or else included in the couple most upstream or the couple most downstream in the upper direction.

Constraint No. 1. To connect a given storage unit to the upper collector Cs, at a first connection point, the system comprises a storage unit upper exit conveyor (Psoa(x), 1) positioned in the upper horizontal plane:
if at least one preparation station upper entry conveyor (Psip(x), 5) is connected to the upper collector downstream in the upper direction or in the alignment of the first connection point; or
if at least one storage unit upper entry conveyor (Psia(x), 18) is connected to the upper collector downstream, in the upper direction, to the first connection point.

Constraint n° 2. To connect the given storage unit to the upper collector Cs at a second connection point, the system comprises a storage unit upper entry conveyor (Psia(x), 18) positioned in the upper horizontal plane:
if at least one preparation station upper exit conveyor (Psop(x), 16) is connected to the upper collector upstream, in the upper direction, or in the alignment of the second connection point;
if at least one storage unit upper exit conveyor (Psoa(x), 1) is connected to the upper collector upstream, in the upper direction, to the second connection point.

Constraint n° 3. To connect a given storage unit to the lower collector Ci at a third connection point, the system comprises a storage unit lower exit conveyor (Pioa(x), 2) positioned in the lower horizontal plane:
if at least one preparation station lower entry conveyor (Piip(x), 6) is connected to the lower downstream collector in the lower direction, or aligned with the third connection point; or
if at least one storage unit lower entry conveyor (Piia(x), 17) is connected to the lower collector downstream, in the lower direction, to the third connection point.

Constraint n° 4. To connect the given storage unit to the lower collector Ci at a fourth connection point, the system comprises a storage unit lower entry conveyor (Piia(x), 17) positioned in the lower horizontal plane:
if at least one preparation station lower exit conveyor (Piop(x), 15) is connected to the lower collector upstream, in the lower direction, or in the alignment of the fourth connection point; or
if at least one storage unit lower exit conveyor (Pioa(x), 2) is connected to the lower collector upstream, in the lower direction, to the fourth connection point.

Constraint n° 5. To connect a given preparation station to the upper collector Cs, at a fifth connection point, the system comprises a preparation station upper exit conveyor (Psop(x), 16) positioned in the upper horizontal plane:
if at least one storage unit upper entry conveyor (Psia(x), 18) is connected to the upper collector downstream, in the upper direction, or in the alignment of the fifth connection point; or
if at least one preparation station upper entry conveyor (Psip(x), 5) is connected to the upper downstream collector, in the upper direction, to the fifth connection point.

Constraint n° 6. To connect a given preparation station to the upper collector Cs, at a sixth connection point, the system comprises a preparation station upper entry conveyor (Psip(x), 5) positioned in the upper horizontal plane:
if at least one storage unit upper exit conveyor (Psoa(x), 1) is connected to the upper collector upstream, in the upper direction, or in the alignment of the sixth connection point; or
if at least one preparation station upper exit conveyor (Psia(x), 16) is connected to the upper collector upstream, in the upper direction, to the sixth connection point.

Constraint n° 7. To connect a given preparation station to the lower collector Ci, at a seventh connection point, the system comprises a preparation station lower exit conveyor (Piop(x), 15) positioned in the lower horizontal plane:
if at least one storage unit lower entry conveyor (Piia(x), 17) is connected to the lower collector downstream, in the lower direction, or in the alignment of the seventh connection point; or
if at least one preparation station lower entry conveyor (6) is connected to the lower collector downstream, in the lower direction, to the seventh connection point.

Constraint n° 8. To connect a given preparation station to the lower collector, at an eighth connection point, the system comprises a preparation station lower entry conveyor (Piip(x), 6) positioned in the lower horizontal plane:
if at least one storage unit lower exit conveyor (Pioa(x), 2) is connected to the lower collector upstream, in the lower direction, or in the alignment of the eighth connection point; or
if at least one preparation station lower exit conveyor (Piop(x), 15) is connected to the lower collector upstream, in the lower direction, to the eighth connection point.

The managing unit UP manages the collectors and conveyors described here above, to enable different types of load transfer that are described in detail here below:
from a storage unit to a preparation station;
between two storage units;
from a preparation station to a storage unit;
between two preparation stations.

Transfer of a Load from a Storage Unit to a Preparation Station

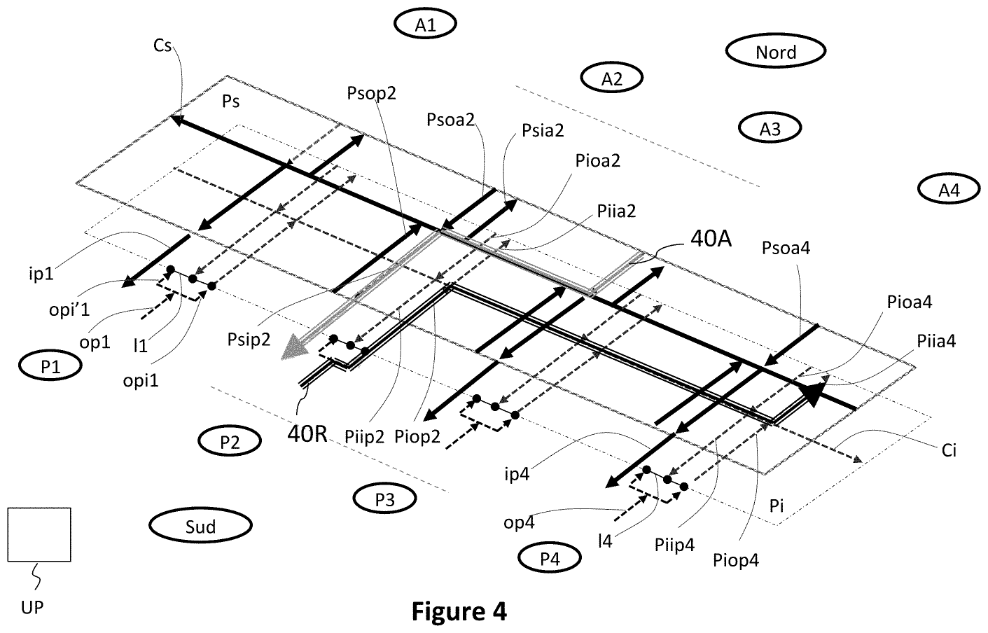

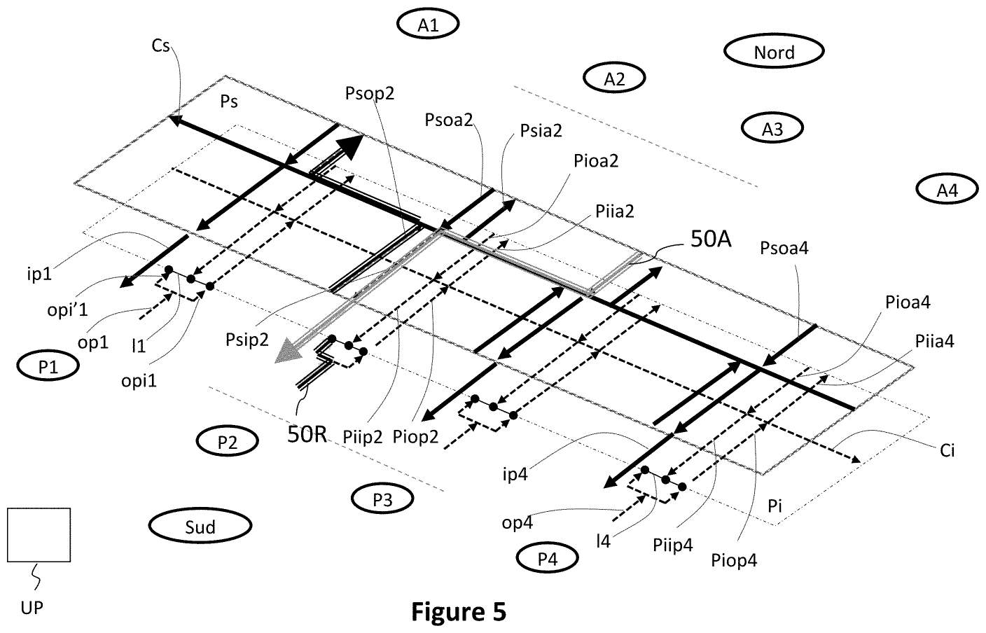

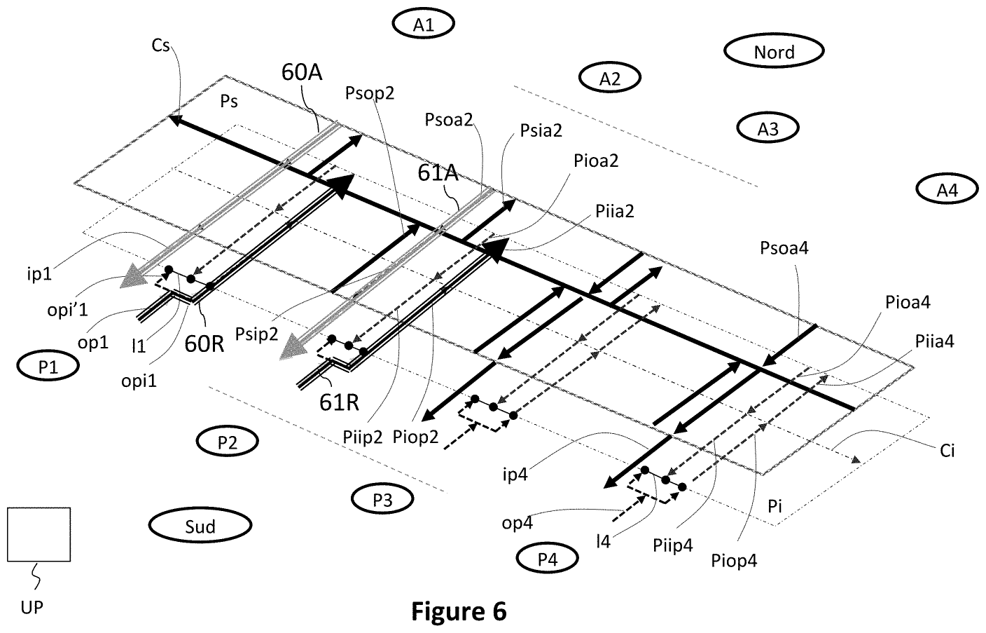

Let us consider the case of a given load that has to be conveyed from a given storage unit to a given preparation unit. The management unit UP is configured so that the load is transported in traveling through a minimum distance:
via the storage unit upper exit conveyor (1) associated with the given storage unit and the preparation station upper entry conveyor (5) associated with the given preparation station, if the preparation station upper entry conveyor (5) associated with the given preparation station is aligned with or downstream, on the upper collector, to the storage unit upper exit conveyor (1) associated with the given storage unit. This is the case with the paths 40A and 50a (between A3 and P2) in FIGS. 4 and 5 and the paths 60A (between A1 and P1) and 61A (between A2 and P2) in FIG. 6;
via the storage unit lower exit conveyor (2) associated with the given storage unit and the preparation station lower entry conveyor (6) associated with the given preparation station if the preparation station lower entry conveyor (6) associated with the given preparation station is aligned with or downstream, on the lower collector, to the storage unit lower exit conveyor (2) associated with the given storage unit.

Transfer of a Load Between Two Storage Units

Let us consider the case of a given load that has to be conveyed from a first given storage unit to a second given storage unit. The management unit UP is configured so that the load is transported in traveling through a minimum distance:
via the storage unit upper exit conveyor (1) associated with the first given storage unit and the storage unit upper entry conveyor (18) associated with the second given storage unit, if the storage unit upper entry conveyor (18) associated with the second given storage unit is downstream, on the upper collector, to the storage unit upper exit conveyor (1) associated with the given storage unit;
via the storage unit lower exit conveyor (2) associated with the first given storage unit and the storage unit lower entry conveyor (17) associated with the second given storage unit, if the storage unit lower entry conveyor (17) associated with the second given storage unit is downstream, on the lower collector, to the storage unit lower exit conveyor (2) associated with the first given storage unit.

Transfer of a Load from a Preparation Station to a Storage Unit

Let us consider the case of a given load that has to be conveyed from a given preparation station to a given storage unit. The management unit UP is configured so that the load is transported in traveling over a minimum distance:
via the preparation station upper exit conveyor (16) associated with the given preparation station and the storage unit upper entry conveyor (18) associated with the given storage unit, if the storage unit upper entry conveyor (18) associated with the given storage unit is aligned with, or downstream on the upper collector, to the preparation station upper exit conveyor (16) associated with the given preparation station. This is the case with the path 50R (between P2 and A1) in FIG. 5;
via the preparation station lower exit conveyor (15) associated with the given preparation station and the storage unit lower entry conveyor (17) associated with the given storage unit, if the storage unit lower entry conveyor (17) associated with the given storage uniform is aligned with or downstream, on the lower collector, to the preparation station lower exit conveyor (15) associated with the given preparation station. This is the case with the path 40R (between P2 and A4) in FIG. 4 and with the paths 60R (between P1 and A1) and 61R (between P2 and A2) in FIG. 6.

Transfer of a Load Between Two Preparation Stations

Let us consider the case of a given load that has to be conveyed from a first given preparation station to a second given preparation station. The management unit UP is configured so that the load is conveyed in traveling through a minimum distance:
via the preparation station upper exit conveyor (16) associated with the first given preparation station and the preparation station upper entry conveyor (5) associated with the second given preparation station, if the preparation station upper entry conveyor (5) associated with the second given preparation station is downstream, on the upper collector, to the preparation station upper exit conveyor (16) associated with the first given preparation station;
via the preparation station lower exit conveyor (15) associated with the first given preparation station and the preparation station lower entry conveyor (6) associated with the second given preparation station, if the preparation station lower entry conveyor (6) associated with the second given preparation station is downstream, on the lower collector, to the preparation station lower exit conveyor (15) associated with the first given preparation station.

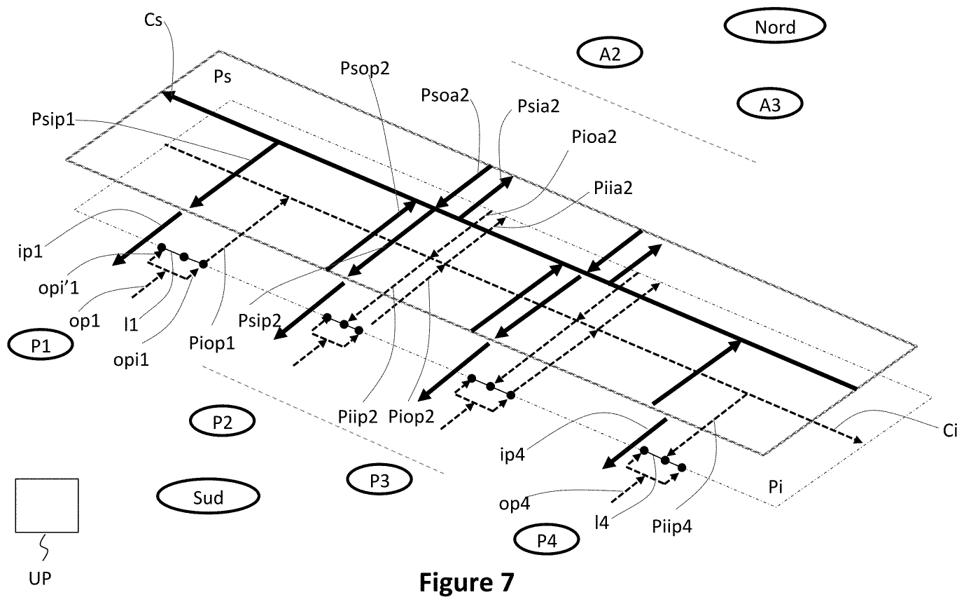

FIG. 7 illustrates a system for conveying loads in a third embodiment of the invention which is distinguished from the first (that of FIG. 2) in that there are fewer storage units (N=2) than preparation stations (M=4).

The storage units A2 and A3 and the preparation stations P2 and P3 form two couples (A2, P2) and (A3, P3) each comprising a storage unit and a preparation station facing each other on either side of the upper and lower collectors Cs, Ci. The preparation stations P1 and P4 do not face any storage unit.

By application of the above-mentioned constraints 1 to 8:
the system does not include any preparation station lower entry conveyor (Piip(x), 6), nor any preparation station upper exit conveyor (Psop(x), 16), for the preparation station P1; and
the system does not include any preparation station lower exit conveyor (Piop(x), 15), nor any preparation station upper entry conveyor (Psip(x), 5), for the preparation station P4.

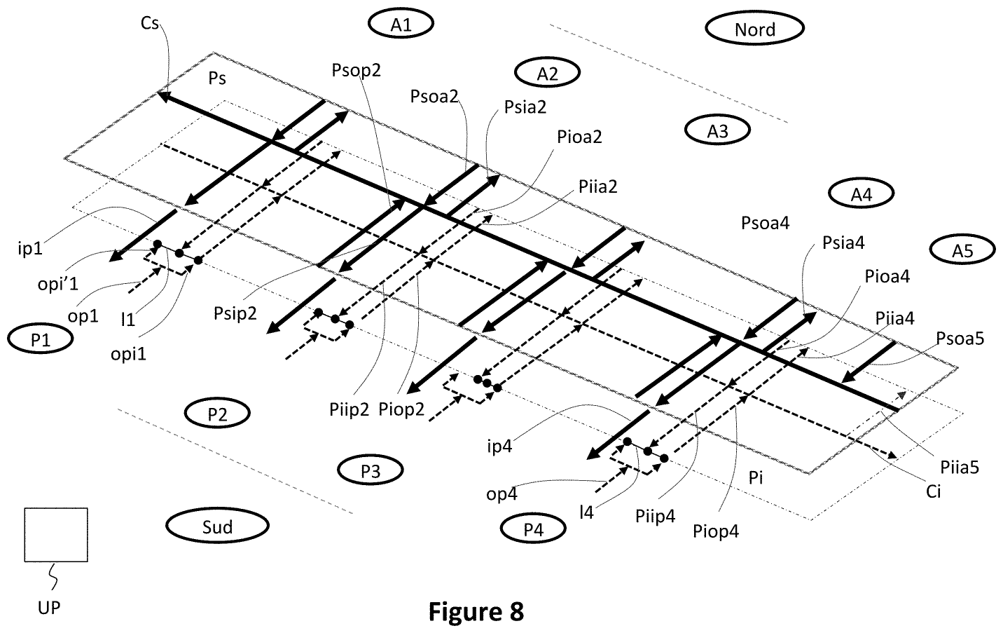

FIG. 8 illustrates a system for conveying loads according to a fourth embodiment of the invention that is distinguished from the first (that of FIG. 2) in that there are more storage units (N=5) than preparation stations (M=4).

The storage units A1, A2, A3 and A4 and the preparation stations P1, P2, P3 and P4 form four couples (A1, P1), (A2, P2), (A3, P3) and (A4, P4) each comprising a storage unit and a preparation station that face each other on either side of the upper and lower collectors Cs, Ci. The storage unit A5 does not face any preparation station.

By the application of the above-mentioned constraints 1 to 8, the system does not include any storage unit upper entry conveyor (Psia(x), 18), nor any storage unit lower exit conveyor (Pioa(x), 2), for the storage unit A5.

FIG. 11 presents an example of a structure of the above-mentioned management unit UP, according to one particular embodiment of the invention. The management unit UP comprises a volatile memory 112 (for example a random-access memory), a processing unit 111 equipped for example with a processor and managed by a computer program 1130 stored in a non-volatile memory 113 (for example a read-only memory or a hard disk drive). At initialization, the code instructions of the computer program are for example loaded into the volatile memory 112 and then executed by the processor of the processing unit 111. The processing unit 111 inputs signals 114, processes them and generates output signals 115.

The input signals 114 comprise various pieces of information on the operating of the general system (comprising especially the storage units, the preparation stations, the collectors, the conveyors, the storage unit exit conveyors, the preparation station entry conveyors, especially the load identifiers read (by barcode or RFID label types of reader devices, etc.) on the loads when they pass by different places in the general system (for example, at the extremities of the different conveyors).

The output signal 115 comprises various pieces of control information for the management of the devices of the general system in order to manage the movements of the loads in the general system.

This FIG. 11 illustrates only one particular implementation among several possible implementations. Indeed, the management unit UP can be made equally well on a reprogrammable computing machine (a PC computer, a DSP processor or a microcontroller) executing a program comprising a sequence of instructions and/or on a dedicated computing machine (for example a set of logic gates such as an FPGA or an ASIC or any other hardware module). Should the management unit be implanted at least partly on a reprogrammable computation machine, the corresponding program (i.e. the sequence of instructions) can be stored in a storage medium that is detachable (such as for example a floppy disk, a CD ROM or a DVD ROM) or not detachable, this storage medium being partially or totally readable by a computer or a processor.

It is clear that many other embodiments of the invention can be envisaged without departing from the framework of the present invention, especially as a function of the values taken by the number N of storage units and the number M of preparation stations (as described further above, through several examples. Three cases are possible: N=M, N<M and N>M).

An exemplary embodiment of the present disclosure overcomes the different drawbacks of the prior art.

An exemplary embodiment provides a system for conveying loads without sequencing, between a plurality of storage units and a plurality of preparation stations, the system not having the drawbacks related to the use of a loop (carrousel).

An exemplary embodiment provides a system of this kind to minimize the distances travelled by the loads and to increase the quality of loads that can be conveyed simultaneously.

An exemplary embodiment provides a system of this kind that has a multiplier effect on the use of the devices that constitute it (in particular collectors and conveyors).

An exemplary embodiment provides a system of this kind that is simple to implement and costs little.

1. A system for conveying loads without sequencing, between a plurality of storage units and a plurality of preparation stations, wherein the system comprises:
an upper load-collecting conveyor and a lower load-collecting conveyor that are rectilinear, parallel, respectively positioned on an upper horizontal plane and a lower horizontal plane, being mono-directional and having opposite directions that are respectively upper and lower directions; and
for at least one first couple comprising a storage unit of the plurality of storage units and a preparation station of the plurality of preparation stations facing each other on either side of the upper and lower load-collecting conveyors, a first set of conveyors composed of:
a storage unit upper exit conveyor and a storage unit lower entry conveyor, positioned in the upper horizontal plane to connect said storage unit to the upper load-collecting conveyor;
a storage unit lower exit conveyor and a storage unit lower entry conveyor, positioned in the lower horizontal plane to connect said storage unit to the lower load-collecting conveyor;
a preparation station upper exit conveyor and a preparation station upper entry conveyor positioned in the upper horizontal plane to connect said preparation station to the upper load-collecting conveyor; and
a preparation station lower exit conveyor and a preparation station lower entry conveyor, positioned in the lower horizontal plane to connect said preparation station to the lower load-collecting conveyor.

2. The system according to claim 1 for a conveying of loads between N storage units and N preparation stations, with N≥3, wherein the system comprises N couples each comprising a storage unit of the plurality of storage units and a preparation station of the plurality of preparation stations that face each other on either side of the upper and lower load-collecting conveyors, and in that said N couples include:
N-2 said first couple(s) for each of which the system comprises said first set of conveyors;
a second couple, further upstream in the upper direction, and for which the system comprises a second set of conveyors identical to said first set of conveyors or distinct from it in that it does not include said storage unit upper entry conveyor; and
a third couple, furthest downstream in the upper direction and for which the system comprises a third set of conveyors identical to said first set of conveyors or distinct from it in that it does not include said preparation station upper exit conveyor.

3. The system according to claim 1 wherein, to connect a given storage unit not included in said at least one first couple to the upper load collecting conveyor at a first connection point, the system comprises a storage unit upper exit conveyor positioned in the upper horizontal plane:
if at least one preparation station upper entry conveyor is connected to the upper load collecting conveyor downstream, in the upper direction, to the first connection point or aligned with the first connection point; or
if at least one storage unit upper entry conveyor is connected to the upper load collecting conveyor downstream, in the upper direction, to the first connection point;
and wherein to connect the given storage unit to the upper load collecting conveyor at a second connection point, the system comprises a storage unit upper entry conveyor positioned in the upper horizontal plane:
if at least one preparation station upper exit conveyor is connected to the upper load collecting conveyor upstream, in the upper direction, to the second connection point or aligned with the second connection point; or
if at least one storage unit upper exit conveyor is connected to the upper load-collecting conveyor, in the upper direction; to the second connection point.

4. The system according to claim 1, wherein to connect a storage unit not included in said at least one couple, to the lower load collecting conveyor at a third connection point, the system comprises a storage unit lower exit conveyor positioned in the lower horizontal plane:
if at least one preparation station lower entry conveyor is connected to the lower load collecting conveyor downstream, in the lower direction, to the third connection point or aligned with the third connection point; or
if at least one storage unit lower entry conveyor is connected to the lower load collecting conveyor downstream, in the lower direction, to the third connection point;
and wherein to connect the given storage unit to the lower load collecting conveyor at a fourth connection point, the system comprises a storage unit lower entry conveyor positioned in the lower horizontal plane;
if at least one preparation station lower exit conveyor is connected to the lower load collecting conveyor upstream, in the lower direction, to the fourth connection point or aligned with the fourth connection point; or
if at least one storage unit lower exit conveyor is connected to the lower load collecting conveyor upstream, in the lower direction, to the fourth connection point.

5. The system according to claim 1, wherein, to connect a given preparation station not included in said at least one first couple to the upper load collecting conveyor, at a fifth connection point, the system comprises a preparation station upper exit conveyor positioned in the upper horizontal plane:
if at least one storage unit upper entry conveyor is connected to the upper load collecting conveyor downstream, in the upper direction, to the fifth connection point or aligned with the fifth connection point; or
if at least one preparation station upper entry conveyor is connected to the upper load collecting conveyor downstream, in the upper direction, to the fifth connection point;
and wherein to connect the given preparation station to the upper load collecting conveyor at a sixth connection point, the system comprises a preparation station upper entry conveyor positioned in the upper horizontal plane:
if at least one storage unit upper exit conveyor is connected to the upper load collecting conveyor upstream, in the upper direction, to the sixth connection point or aligned with sixth connection point; or
if at least one preparation station upper exit conveyor is connected to the upper load collecting conveyor upstream, in the upper direction, to the sixth connection point.

6. The system according to claim 1, wherein, to connect a given preparation station, not included in said at least one first couple, to the lower load collecting conveyor, at a seventh connection point, the system comprises a preparation station lower exit conveyor positioned in the lower horizontal plane:
if at least one lower entry conveyor of the storage unit is connected to the lower load collecting conveyor downstream, in the lower direction, to said seventh connection point or aligned with said seventh connection point; or
if at least one preparation station lower entry conveyor is connected to the lower load collecting conveyor downstream, in the lower direction, to the seventh connection point;
and wherein, to connect the given preparation station to the lower load collecting conveyor at an eighth connection point, the system comprises a preparation station lower entry conveyor positioned in the lower horizontal plane:
if at least one storage unit lower exit conveyor is connected to the lower load collecting conveyor upstream, in the lower direction, or to the eighth connection point or aligned with the eighth connection point; or
if at least one preparation station lower exit conveyor is connected to the lower load collecting conveyor upstream, in the lower direction, to the eighth connection point.

7. The system according to claim 1, wherein said conveyors other than said load collecting conveyors are perpendicular to said load collecting conveyors.

8. The system according to claim 1, a given load having to be conveyed from a given storage unit to a given preparation station, wherein the system comprises a management unit for managing the storage units, preparation stations, and conveyors, said management unit being configured so that the load is transported in travelling through a minimum distance:
via the storage unit upper exit conveyor associated with the given storage unit and the preparation station upper entry conveyor associated with the given preparation station, if the preparation station upper entry conveyor associated with the given preparation station is aligned with or downstream, on the upper load collecting conveyor, to the storage unit upper exit conveyor associated with the given storage unit;
via the storage unit lower exit conveyor associated with the given storage unit and the preparation station lower entry conveyor associated with the given preparation station, if the preparation station lower entry conveyor associated with the given storage unit lower exit conveyor is aligned with or downstream, on the lower load collecting conveyor, to the storage unit lower exit conveyor associated with the given storage unit.

9. The system according to claim 1, a given load having to be conveyed from a given first storage unit to a given second storage unit of the plurality of storage units, wherein the system comprises a management unit for managing the storage units, preparation stations, and conveyors, said management unit being configured so that the load is transported in travelling through a minimum distance:
via the storage unit upper exit conveyor associated with the first given storage unit, and the storage unit upper entry conveyor associated with the second storage unit, if the storage unit upper entry conveyor associated with the given second storage unit is downstream, on the upper load-collecting conveyor, to the storage unit upper exit conveyor associated with the given storage unit;
via the storage unit lower exit conveyor associated with the given first storage unit and the storage unit lower entry conveyor associated with the second given storage unit, if the storage unit lower entry conveyor associated with the second given storage unit is downstream, on the lower load collecting conveyor, to the storage unit lower exit conveyor associated with the first given storage unit.

10. The system according to claim 1, a given load having to be conveyed from a given preparation station of the plurality of preparation stations to a given storage unit of the plurality of storage units, wherein the system comprises a management unit for managing the storage units, preparation stations, and conveyors, said management unit being configured so that the load is transported in travelling through a minimum distance:
via the preparation station upper exit conveyor associated with the given preparation station, if the storage unit upper entry conveyor associated with the given storage unit is aligned with or downstream; on the upper load collecting conveyor, to the preparation station upper load collecting conveyor associated with the given preparation station;
via the preparation station lower exit conveyor associated with the given preparation station and the storage unit lower entry conveyor associated with the given storage unit, if the storage unit lower entry conveyor associated with the given storage unit is aligned with or downstream, on the lower load collecting conveyor, to the preparation station lower exit conveyor associated with the given preparation station.

11. The system according to claim 1, a given load having to be conveyed from a first given preparation station to a second given preparation station of the plurality of preparation stations, wherein the system comprises a management unit for managing the storage units, the preparation stations, and the conveyors, said management unit being configured so that the load is transported in traveling through a minimum distance:
via the preparation station upper exit conveyor associated with the given first preparation station and the preparation station upper entry conveyor associated with the given second preparation station, if the preparation station upper entry conveyor associated with the second given preparation station, is downstream, on the upper load collecting conveyor, to the preparation station upper exit conveyor associated with the first given preparation station;
via the preparation station lower exit conveyor associated with the first given preparation station and the preparation station lower entry conveyor associated with the second given preparation station, if the preparation station lower entry conveyor associated with the second given preparation station is downstream, on the lower load collecting conveyor, to the preparation station lower exit conveyor associated with the first given preparation station.

12. The system according to claim 1 wherein, for said at least one first couple comprising a storage unit of the plurality of storage units and a preparation station of the plurality of preparation stations facing each other, the storage unit upper exit conveyor is aligned with the preparation station upper entry conveyor.

13. The system according to claim 1 wherein, for said at least one first couple comprising a storage unit of the plurality of storage units and a preparation station of the plurality of preparation stations facing each other, the storage unit lower exit conveyor is aligned with the preparation station lower entry conveyor.

14. The system according to claim 1 wherein, for said at least one couple comprising a storage unit of the plurality of storage units and a preparation station of the plurality of preparation stations facing each other, the preparation station lower exit conveyor is aligned with the storage unit lower entry conveyor.

15. The system according to claim 1 wherein, for said at least one first couple comprising a storage unit of the plurality of storage units and a preparation station of the plurality of preparation stations facing each other:
the preparation station lower exit conveyor is downstream, in the lower direction, to the preparation station lower entry conveyor; and
the preparation station upper exit conveyor is downstream, in the upper direction, to the preparation station upper entry conveyor.

16. The system according to claim 1 wherein, for said at least one first couple comprising a storage unit of the plurality of storage units and a preparation station of the plurality of preparation stations facing each other:
the storage unit upper exit conveyor and the storage unit lower exit conveyor are superimposed; and
the preparation unit upper entry conveyor and the preparation unit lower entry conveyor are superimposed.

17. The system according to claim 1 wherein the upper load collecting conveyor and the lower load collecting conveyor are superimposed.

18. The system according to claim 1 wherein, for at least one of the preparation stations, the system comprises:
a preparation station final entry conveyor;
a preparation station initial exit conveyor;
a first interface device on the one hand the preparation station upper entry conveyor and the preparation station lower entry conveyor, and on the other hand the preparation station final entry conveyor; and
a second interface device between on the one hand the preparation station initial exit conveyor and on the other hand the preparation station upper exit conveyor and the preparation station lower exit conveyor.

19. The system according to claim 18, wherein the preparation station upper exit conveyor and the preparation station lower entry conveyor are superimposed and said first interface device comprises a first elevator configured for:
a first transfer of loads from the preparation station upper entry conveyor to the preparation station final entry conveyor; and
a second transfer of loads from the preparation station lower entry conveyor to the preparation station final entry conveyor.

20. The system according to claim 19, wherein the first elevator comprises a lower level and upper level superimposed and configured to simultaneously enable:
the loading on said upper level of a load coming from the preparation station upper entry conveyor, for said first load transfer; and
the loading on said lower level of a load coming from the preparation station lower entry conveyor, for said second load transfer.

21. The system according to claim 19, wherein the preparation station initial exit conveyor is positioned in the lower horizontal plane and wherein said second interface device comprises:
a first intermediate lower conveyor positioned in the lower horizontal plane, along a first lower axis parallel to a first upper axis of the preparation station upper exit conveyor;
a second intermediate lower conveyor positioned in the lower horizontal plane along a same second lower axis as the preparation station lower exit conveyor;
a second elevator configured for a third transfer of loads from the first intermediate lower conveyor to the preparation station upper exit conveyor;
a junction conveyor or a third elevator configured for a fourth transfer of loads from the second intermediate lower conveyor towards the preparation station lower exit conveyor.

22. The system according to claim 21, wherein the first and second elevators and the third elevator, if any, are made in the form of a single elevator comprising, on a same lower level, first, second and third elevator conveyors configured to carry out respectively the second and third transfer of loads and eventually the fourth transfer of loads.
